(19) United States
(12) Patent Application Publication
(10) Pub. No.: US 2012/0148818 A1
(43) Pub. Date: Jun. 14, 2012

(54) NOVEL FLUORINE-CONTAINING COPOLYMER AND MEMBRANE

(75) Inventors: Safir L. ADAM, Santa Clara, CA (US); Song Li, Santa Clara, CA (US); Shinji Okada, Tokyo (JP); Nobuyuki Kasahara, Tokyo (JP); Katsuya Ueno, Tokyo (JP); Yoshitomi Morizawa, Tokyo (JP); Takashi Okazoe, Tokyo (JP)

(73) Assignee: ASAHI GLASS COMPANY LIMITED, Tokyo (JP)

(21) Appl. No.: 13/362,630

(22) Filed: Jan. 31, 2012

Related U.S. Application Data
(63) Continuation of application No. PCT/JP2010/063145, filed on Jul. 28, 2010.

(30) Foreign Application Priority Data
Jul. 31, 2009 (JP) 2009-178797

(51) Int. Cl. C08F 214/24; B32B 27/28; C09D 127/12

(52) U.S. Cl. 428/220; 526/249; 526/245; 524/544

(57) ABSTRACT

A fluorine-containing copolymer, containing: chlorotrifluoroethylene monomer units (A); and monomer units (B), which are obtained by polymerizing a monomer selected from the group consisting of (i) a monomer having a formula: CH₂═CHCOON(R⁰)₂, wherein each R⁰ is independently a hydrogen or an alkyl group; (ii) N-vinylcaprolactam; (iii) a monomer having a formula: CH₂═CR¹CH₂OCH₂CR²═CH₂, wherein R¹ and R² are each independently a hydrogen, a fluorine, or a methyl group; (iv) a monomer having a formula: CH₂═CHCH₂CH(CH₃)—R³, wherein R³ is a linear alkyl group comprising 1 to 7 carbons; and (v) a monomer of methyl 2-fluoroacrylate, wherein a ratio, (A)/((A)+(B)), is from 3 to 99 mol %, a fluorine content of the copolymer is from 15 to 75 mol %, and a molecular weight of the copolymer is from 1,000 to 1,000,000.

### TECHNICAL FIELD

The present invention relates to a fluorine-containing copolymer excellent in oxygen shielding performance and moisture shielding performance (hereinafter, the fluorine-containing copolymer is referred to simply as copolymer). The fluorine-containing copolymer of the present invention is useful as a film such as a food packaging film, an electronic part packaging film, a medicament packaging film, a barrier film for organic EL, a gas barrier film for LCD or the like, which requires oxygen shielding ability, as a coating agent for an LED encapsulating film, a coating film for solar cell, or the like, or as a coating agent or a film for imparting moisture shielding performance and oxygen shielding performance to a surface sheet or a back sheet of a solar battery.

### BACKGROUND ART

A polymer having oxygen shielding performance may be usefully used as a material for a food packaging film, an electronic part packaging film, a medicament packaging film, a gas barrier film for organic EL, a gas barrier film for LCD, an LED encapsulating film and the like. Moreover, the fluorine-containing copolymer has properties such as high water and oil repellency, high heat resistance, high chemical resistance, high weather resistance and the like.

However, there are quite a number of reports on fluorine-containing copolymers having not only oxygen shielding ability but also the other properties. For example, there are reports on oxygen shielding performance and moisture shielding performance of polychlorotrifluoroethylene (hereinafter referred to as PCTFE) obtained by polymerizing chlorotrifluoroethylene (hereinafter referred to as CTFE) and a copolymer of CTFE with vinylidene fluoride (Non-Patent Literature 1).

Moreover, there is a report wherein moisture permeability and physical properties have been studied on films of PCTFE containing up to 1% by weight of a copolymerizable comonomer (Patent Literature 1).

Furthermore, as binary copolymers of CTFE, copolymers of CTFE and propylene and copolymers of CTFE and vinyl esters are known (Non-Patent Literature 2, Patent Literature 2). Additionally, as copolymers of CTFE, a variety of copolymers consisting of three or more components are also known.

### CITATION LIST

### Patent Literature

Patent Literature 1: JP-H6-511271
Patent Literature 2: British Patent No. 596943

### Non-Patent Literature

Non-Patent Literature 1: A. W. Myers, V. Tammela, V. Stannett, and M. Szwarc, Mod. Plast. 37, 10, 139 (1960)
Non-Patent Literature 2: Toshikazu Koyama, Takaomi Satogawa et al., Journal of Synthetic Organic Chemistry, Japan, 31, No. 6, 518 (1973)

### SUMMARY OF INVENTION

However, PCTFE has a high molding temperature owing to a high crystallinity. Moreover, PCTFE has a low solubility in organic solvents owing to a high fluorine content. Therefore, it is difficult to form PCTFE into a shape of a membrane or the like.

With regard to the copolymers of CTFE, since CTFE has a low copolymerizability, monomers copolymerizable with CTFE are limited. Moreover, since it is generally difficult to obtain one having a high molecular weight as a copolymer of CTFE, it is difficult to form it into a self-standing membrane.

Moreover, according to the studies of the present inventors, most of the ternary copolymers thereof have a low oxygen shielding ability and thus are difficult to be put into practical use. Moreover, with regard to the ternary copolymers, reaction control is difficult and control of the monomer composition in the copolymer is generally difficult. Furthermore, in the case of the use in the aforementioned use applications, a property of non-permeability of moisture (moisture shielding ability) is also required but there is no report on a polymer excellent in oxygen permeability and forming processability while the property is maintained.

An object of the present invention is to provide a fluorine-containing copolymer, which is a binary copolymer of CTFE and a monomer copolymerizable with CTFE, satisfies both of oxygen shielding performance and solubility in an organic solvent and formability, and is excellent in practical usefulness as compared with PCTFE, as well as a membrane obtained from the fluorine-containing copolymer.

The present invention provides the following inventions:

(1) A fluorine-containing copolymer consisting essentially of monomer units (A) of chlorotrifluoroethylene and monomer units (B) as described below, and having a ratio of the number of moles of the monomer unit (A) to the total number of moles of the monomer unit (A) and the monomer unit (B) of from 3 to 99% by mole, a fluorine content as described below of from 15 to 75% by mole, and a molecular weight of from 1,000 to 1,000,000:

monomer unit (B): a unit derived from polymerization of any one monomer selected from the group consisting of a monomer represented by the formula)CH₂═CHCOON(R⁰)₂, wherein the two R⁰'s may be the same or different and R⁰ represents a hydrogen atom or an alkyl group; N-vinylcaprolactam; a monomer represented by the formula CH₂═CR¹CH₂OCH₂CR²═CH₂, wherein R¹ and R² each independently represent a hydrogen atom, a fluorine atom, or a methyl group; a monomer represented by the formula CH₂═CHCH₂CH(CH₃)—R³, wherein R³ represents a liner alkyl group having 1 to 7 carbon atoms; and a monomer of methyl 2-fluoroacrylate;

fluorine content: a ratio of the total number of moles of fluorine atoms to the total number of moles of halogen atoms and hydrogen atoms bonded to carbon atoms of the fluorine-containing copolymer;

(2) The fluorine-containing copolymer according to (1), wherein the monomer unit (B) is a unit derived from polymerization of a monomer represented by the formula)CH₂═CHCOON(R⁰)₂, and

the ratio of the number of moles of the monomer unit (A) to the total number of moles of the monomer unit (A) and the monomer unit (B) is from 16 to 99% by mole and a ratio of the number of moles of the monomer unit (B) to the total number of moles is from 84 to 1% by mole;

(3) The fluorine-containing copolymer according to (1), wherein the monomer unit (B) is a unit derived from polymerization of N,N-dimethylacrylamide, and

the ratio of the number of moles of the monomer unit (A) to the total number of moles of the monomer unit (A) and the monomer unit (B) is from 36 to 60% by mole and the ratio of the number of moles of the monomer unit (B) to the total number of moles is from 64 to 40% by mole;

(4) The fluorine-containing copolymer according to (1), wherein the monomer unit (B) is a unit derived from polymerization of N-vinylcaprolactam, and the ratio of the number of moles of the monomer unit (A) to the total number of moles of the monomer unit (A) and the monomer unit (B) is from 45 to 99% by mole and the ratio of the number of moles of the monomer unit (B) to the total number of moles is from 55 to 1% by mole;

(5) The fluorine-containing copolymer according to (1), wherein the monomer unit (B) is a unit derived from polymerization of a monomer represented by the formula CH₂═CR¹CH₂OCH₂CR²═CH₂, wherein R¹ and R² represent the same meanings as described above, and

the ratio of the number of moles of the monomer unit (A) to the total number of moles of the monomer unit (A) and the monomer unit (B) is from 10 to 99% by mole and the ratio of the number of moles of the monomer unit (B) to the total number of moles is from 90 to 1% by mole;

(6) The fluorine-containing copolymer according to (1), wherein the monomer unit (B) is a unit derived from polymerization of a monomer represented by the formula CH₂═CHCH₂CH(CH₃)—R³, wherein R³ represents the same meaning as described above, and

the ratio of the number of moles of the monomer unit (A) to the total number of moles of the monomer unit (A) and the monomer unit (B) is from 43 to 99% by mole and the ratio of the number of moles of the monomer unit (B) to the total number of moles is from 57 to 1% by mole;

(7) The fluorine-containing copolymer according to (1), wherein the monomer unit (B) is a unit derived from polymerization of a monomer represented by the formula CH₂═CHCH₂CH(CH₃)₂, and

the ratio of the number of moles of the monomer unit (A) to the total number of moles of the monomer unit (A) and the monomer unit (B) is from 43 to 70% by mole and the ratio of the number of moles of the monomer unit (B) to the total number of moles is from 57 to 30% by mole.

(8) The fluorine-containing copolymer according to (1), wherein the monomer unit (B) is a unit derived from polymerization of a monomer of methyl 2-fluoroacrylate, and

the ratio of the number of moles of the monomer unit (A) to the total number of moles of the monomer unit (A) and the monomer unit (B) is from 3 to 20% by mole and the ratio of the number of moles of the monomer unit (B) to the total number of moles is from 97 to 80% by mole;

(9) The fluorine-containing copolymer according to any one of (1) to (8), having an oxygen permeability coefficient of from 0 to 20 (cm³·mm)/(m²·day·atm) at 40° C.;

(10) A membrane which is formed from a fluorine-containing copolymer consisting essentially of monomer units (A) of chlorotrifluoroethylene and monomer units (B) as described below, and having a ratio of the number of moles of the monomer unit (A) to the total number of moles of the monomer unit (A) and the monomer unit (B) of from 3 to 99% by mole, a fluorine content as described below of from 15 to 75% by mole and a molecular weight of from 1,000 to 1,000,000; and which has an oxygen permeability coefficient of from 0 to 20 (cm³·mm)/(m²·day·atm) at 40° C.:

monomer unit (B): a unit derived from polymerization of any one monomer selected from the group consisting of a monomer represented by the formula)CH₂═CHCOON(R⁰)₂, wherein the two R⁰'s may be the same or different and R⁰ represents a hydrogen atom or an alkyl group; N-vinylcaprolactam; a monomer represented by the formula CH₂═CR¹CH₂OCH₂CR²═CH₂, wherein R¹ and R² each independently represent a hydrogen atom, a fluorine atom, or a methyl group; a monomer represented by the formula CH₂═CHCH₂CH(CH₃)—R³, wherein R³ represents a liner alkyl group having 1 to 7 carbon atoms; and a monomer of methyl 2-fluoroacrylate;

fluorine content: a ratio of the total number of moles of fluorine atoms to the total number of moles of halogen atoms and hydrogen atoms bonded to carbon atoms of the fluorine-containing copolymer;

(11) The membrane according to (10), having a thickness of the membrane of from 0.05 to 2,000 μm;

(12) The membrane according to (10) or (11), which is a film or a coating membrane; and

(13) A process for producing a coating membrane, which comprises applying an organic solvent solution containing the fluorine-containing copolymer according to any one of (1) to (9) and an organic solvent onto a substrate and subsequently drying the solution to form a membrane of the fluorine-containing copolymer on the substrate.

According to the present invention, there is provided a fluorine-containing copolymer, which is a copolymer of CTFE and a specific monomer copolymerizable with CTFE, satisfies both of oxygen shielding performance and solubility in an organic solvent and formability, and is excellent in practical usefulness as compared with PCTFE. Additionally, there can be provided a useful membrane obtained from the fluorine-containing copolymer.

### DESCRIPTION OF EMBODIMENTS

In the specification, a monomer unit means a unit derived from polymerization of a monomer. It is also a repeating unit formed in a polymer by polymerization of a monomer. In the specification, the monomer represented by the formula (1) is referred to as a monomer (1) and the monomer unit formed of the monomer (1) is referred to as a monomer unit (1) in some cases. Moreover, the symbols in the specification represent the same meaning as described above unless otherwise specified.

The fluorine-containing copolymer of the present invention is a copolymer consisting essentially of monomer units (A) of chlorotrifluoroethylene (CTFE) and monomer units (B) of a specific monomer copolymerizable with CTFE.

The monomer unit (B) is a unit derived from polymerization of any one monomer selected from the group consisting of a monomer represented by the formula)CH₂═CHCOON(R⁰)₂ (B1), wherein the two R⁰'s may be the same or different and R⁰ represents a hydrogen atom or an alkyl group; N-vinylcaprolactam (B2); a monomer represented by the formula CH₂═CR¹CH₂OCH₂CR²═CH₂ (B3), wherein R¹ and R² each independently represent a hydrogen atom, a fluorine atom, or a methyl group; a monomer represented by the formula CH₂═CHCH₂CH(CH₃)—R³ (B4), wherein R³ represents a liner alkyl group having 1 to 7 carbon atoms; and a monomer of methyl 2-fluoroacrylate (B5).

The monomer unit (B) in the fluorine-containing copolymer is one kind. However, in the case where the monomer unit (B) is expressed by a general formula or a superordinate concept, a plurality of monomer units (B) included in the general formula or the superordinate concept are interpreted as one kind even in the case where the chemical structures thereof are different, and thus monomer units (B) having two or more different chemical structures may be adopted. The monomer unit (B) is preferably a monomer unit based on one kind of monomer unit having the same chemical structure.

As the monomer (B1) represented by the formula)CH₂═CHCOON(R⁰)₂ wherein the two R⁰'s may be the same or different and R⁰ represents a hydrogen atom or an alkyl group in the monomer unit (B1), a compound wherein R⁰ 's are the same is preferred and acrylamide or an N,N-dialkylacrylamide is particularly preferred. In the case where R⁰ is an alkyl group, the number of carbon atoms is preferably 1 to 3, and a methyl group is particularly preferred. Namely, as the N,N-dialkylacrylamide, N,N-dimethylacrylamide is preferred.

N-vinylcaprolactam (B2) in the monomer unit (B2) is a compound represented by the following formula (B2).

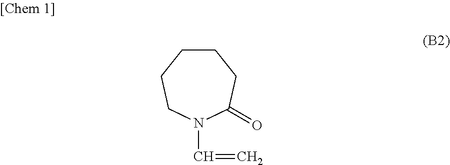

As the monomer (B3) represented by the formula CH₂═CR¹CH₂OCH₂CR²═CH₂ wherein R¹ and R² each independently represent a hydrogen atom, a fluorine atom, or a methyl group in the monomer unit (B3), CH₂═C(CH₃)CH₂OCH₂C(CH₃)═CH₂, CH₂═CHCH₂OCH₂CH═CH₂, CH₂═CFCH₂OCH₂C(CH₃)═CH₂, CH₂═CFCH₂OCH₂CF═CH₂, CH₂═CFCH₂OCH₂CH═CH₂, and the like may be mentioned. CH₂═C(CH₃)CH₂OCH₂C(CH₃)═CH₂ and CH₂═CHCH₂OCH₂CH═CH₂ are preferred and CH₂═CHCH₂OCH₂CH═CH₂ is particularly preferred. As the monomer unit (B3) derived from polymerization of the monomer, a monomer unit wherein the monomer undergoes addition polymerization at one end, a monomer unit wherein the monomer undergoes addition polymerization at the both end, and a monomer unit wherein the monomer undergoes cyclic polymerization may be mentioned and the ratios thereof are not particularly limited.

As the monomer (B4) represented by the formula CH₂═CHCH₂CH(CH₃)—R³ in the monomer unit (B4), CH₂═CHCH₂CH(CH₃)—CH₂CH₃, CH₂═CHCH₂CH(CH₃)₂ and the like are preferred and CH₂═CHCH₂CH(CH₃)₂ is particularly preferred.

Methyl 2-fluoroacrylate (B5) in the monomer unit (B) is a compound represented by the formula CH₂═CF—COOCH₃.

As the above monomer unit (B), from the viewpoint of the moisture shielding performance, CH₂═CHCH₂CH(CH₃)₂ (4-methyl-1-pentene), N-vinylcaprolactam, and CH₂═CHCH₂OCH₂CH═CH₂ (diallyl ether) are preferred. From the viewpoint of the oxygen shielding performance, N-vinylcaprolactam, methyl 2-fluoroacrylate and diallyl ether are preferred and particularly, N-vinylcaprolactam is preferred.

The fluorine-containing copolymer of the present invention consists essentially of the monomer unit (A) and the monomer unit (B). Namely, the ratio of the total number of moles of the monomer unit (A) and the monomer unit (B) to the total number of moles of all the monomer units in the copolymer is 100% by mole. The term “100% by mole” means that any monomer unit other than the monomer unit (A) and the monomer unit (B) is not contained or, if contained, is not detected when the copolymer is qualitatively analyzed by an analytical method such as NMR. The fluorine-containing copolymer preferably consists of the monomer unit (A) of CTFE and the monomer unit (B).

The ratios of the monomer units in the copolymer are preferably 3 to 99% by mole for the monomer unit (A) of CTFE and 97 to 1% by mole for the monomer unit (B). Furthermore, preferred ratios of the monomer units for exhibiting objective performance of the present invention will be described below for each kind of the monomer unit (B). The ratios of the monomer units in the copolymer can be determined by converting data measured by AQF-IC method, NMR method, or the like to be mentioned later.

With regard to the ratio of the monomer unit (B) in the case where the monomer unit is the monomer unit (B1), it is preferred that the ratio of the monomer unit (A) is from 16 to 99% by mole and the ratio of the monomer unit (B1) is from 84 to 1% by mole and it is particularly preferred that the monomer unit (A) is from 36 to 60% by mole and the monomer unit (B1) is from 64 to 40% by mole.

With regard to the ratio of the monomer unit (B) in the case where the monomer unit is the monomer unit (B2) of N-vinylcaprolactam, it is preferred that the ratio of the monomer unit (A) is from 45 to 99% by mole and the ratio of the monomer unit (B2) is from 55 to 1% by mole, it is particularly preferred that the ratio of the monomer unit (A) is from 45 to 90% by mole and the ratio of the monomer unit (B2) is from 55 to 10% by mole, and it is most preferred that the ratio of the monomer unit (A) is from 45 to 85% by mole and the ratio of the monomer unit (B2) is from 55 to 15% by mole.

With regard to the ratio of the monomer unit (B) in the case where the monomer unit is the monomer unit (B3) of the monomer (B3) represented by the formula CH₂═CR¹CH₂OCH₂CR²═CH₂, it is preferred that the ratio of the monomer unit (A) is from 10 to 99% by mole and the ratio of the monomer unit (B3) is from 90 to 1% by mole and it is particularly preferred that the ratio of the monomer unit (A) is from 39 to 85% by mole and the ratio of the monomer unit (B1) is 61 to 15% by mole.

With regard to the ratio of the monomer unit (B) in the case where the monomer unit is the monomer unit (B4) of the monomer (B4) represented by the formula CH₂═CHCH₂CH(CH₃)—R³, it is preferred that the ratio of the monomer unit (A) is from 43 to 99% by mole and the ratio of the monomer unit (B4) is from 57 to 1% by mole. Furthermore, in the case where R³ is a methyl group, it is particularly preferred that the ratio of the monomer unit (A) is from 43 to 70% by mole and the ratio of the monomer unit (B4) is from 57 to 30% by mole. In the case where R³ is a linear alkyl group having 2 to 7 carbon atoms, it is particularly preferred that the ratio of the monomer unit (A) is from 43 to 99% by mole and the ratio of the monomer unit (B4) is from 57 to 1% by mole.

With regard to the ratio of the monomer unit (B) in the case where the monomer unit is the monomer unit (B5) of methyl 2-fluoroacrylate, it is preferred that the ratio of the monomer unit (A) is from 3 to 40% by mole and the ratio of the monomer unit (B5) is from 97 to 60% by mole and it is particularly preferred that the ratio of the monomer unit (A) is from 3 to 20% by mole and the ratio of the monomer unit (B5) is from 97 to 80% by mole.

The molecular weight (weight-average molecular weight) of the fluorine-containing copolymer is preferably from 1,000 to 1,000,000, more preferably from 3,000 to 1,000,000, particularly preferably from 5,000 to 500,000, and most preferably from 10,000 to 200,000. Particularly, in the case where the monomer unit (B) is 4-methyl-1-penten, the molecular weight is preferably from 3,000 to 20,000. In the case where the monomer unit (B) is diallyl ether, the molecular weight is preferably from 2,000 to 20,000. In the case where the monomer unit (B) is vinylcaprolactam, the molecular weight is preferably from 10,000 to 100,000. In the case where the monomer unit (B) is N,N-dimethylacrylamide, the molecular weight is preferably from 100,000 to 120,000.

The molecular weight in the present specification is a value measured by gel permeation chromatography (hereinafter referred to as GPC). GPC can be measured using tetrahydrofuran as a mobile phase, two columns of PLgel MIXED-B column (trade name, manufactured by Polymer Laboratories) connected in tandem as analytical columns, standard polystyrenes (manufactured by Polymer Laboratories) as standard samples for molecular weight measurement, a mobile phase flow rate of 1.0 mL, a column temperature of 30° C., and an evaporation light scattering detector as a detector.

The fluorine content of the fluorine-containing copolymer is from 15 to 75% by mole, preferably from 15 to 70% by mole. The fluorine content in the specification is a ratio of the total number of moles of the fluorine atom to the total number of moles of the halogen atoms (e.g., fluorine atom, chlorine atom, etc.) and the hydrogen atom bonded to the carbon atom of the fluorine-containing copolymer. In the case where the fluorine content is less than the above range, the oxygen shielding ability and the moisture shielding ability to be mentioned later becomes insufficient. The fluorine content in the copolymer can be determined, for example, by converting data measured by AQF-IC method, NMR method, or the like to be mentioned later.

As a process for producing the fluorine-containing copolymer of the present invention, any known method known as a process for polymerizing CTFE can be adopted and the production is preferably effected by a solution polymerization method.

In the present invention, one characteristic feature is a point that a comonomer excellent in copolymerization with CTFE is selected. According to the present invention, a copolymer having a high molecular weight is obtained and the copolymer having a high molecular weight is usable in various use applications as a copolymer excellent in practical usefulness. Moreover, the monomer unit (B) of the fluorine-containing copolymer of the present invention has a C—H bond and a specific side chain donating to the solubility in organic solvents and the like. Therefore, the copolymer has a high solubility in organic solvents as compared with PCTFE having no hydrogen atom and has an advantage that the copolymer can be formed into a shape such as a membrane, as a solvent solution.

The fluorine-containing copolymer of the present invention has an excellent oxygen shielding performance. Moreover, since the copolymer is also excellent in solubility in an organic solvent and formability, it can be formed into a membrane and used in various use applications where oxygen shielding performance is required.

The use applications include films such as a food packaging film, an electronic part packaging film, a medicament packaging film, a gas barrier film for organic EL, and a gas barrier film for LCD, an LED encapsulating film, a coating agent or a film for forming a weather-resistant layer of a solar battery module, and the like.

For using such use applications, it is preferred to form the fluorine-containing copolymer of the present invention into a shape of a membrane such as a film or a coating membrane.

As a process for producing the membrane, a process for forming a membrane of the copolymer on a substrate by applying an organic solution containing the copolymer and an organic solvent onto the substrate and subsequently drying the solution is preferred. Furthermore, a film as a self-standing membrane may be obtained by a process of peeling a membrane from the substrate or the membrane may be left on the surface of the substrate as a coating membrane.

Examples of the organic solvent include propylene glycol monomethyl ether acetate, cyclohexanone, dimethylheptanone, xylene, hexafluoro-m-xylene, heptacosafluorotributylamine, and perfluoromethyldecalin. Moreover, examples of the base material constituting the substrate include a polycarbonate film base material, a PET film base material, a polyvinyl chloride film base material, and a polypropylene film base material.

In the case where the copolymer is dissolved in the organic solvent, the ratio of mass of the copolymer to the mass of the organic solvent is preferably from 1 to 40% by mole and more preferably from 1 to 20% by mole. Since the fluorine-containing copolymer of the present invention is excellent in solubility in an organic solvent, it can form an organic solution of a high concentration.

In the case where the membrane is a self-standing membrane, a method of heating the fluorine-containing copolymer to a temperature equal to or higher than the glass transition temperature thereof, followed by using a melt press machine to effect formation membrane by pressing can be adopted.

In the case where a membrane composed of the fluorine-containing copolymer of the present invention, it is preferred to form the membrane after the copolymer obtained by the polymerization reaction is subjected to a treatment for purification.

The extent of shielding performance of the fluorine-containing copolymer of the present invention or a membrane thereof against oxygen can be represented by an oxygen permeability coefficient. The oxygen permeability coefficient is a value shown by converting, in terms of a film thickness of 1 mm, an amount of oxygen permeated at 40° C. at 1 atm through a membrane having an area of 1 square meter over a period of 1 day. Thus, it is meant that the smaller the value is, the more difficult the permeation of oxygen is, that is, the more excellent the oxygen shielding performance is.

The fluorine-containing copolymer of the present invention has an oxygen permeation coefficient of preferably 0 to 20 cm³·mm/(m²·day·atm) and more preferably 0 to 10 cm³·mm/(m²·day·atm). The membrane which is formed from the fluorine-containing copolymer of the present invention has an oxygen permeation coefficient of 0 to 20 cm³·mm/(m²·day·atm), preferably 0 to 10 cm³·min/(m²·day·atm). The oxygen permeation coefficient can be measured by the principle to be described in Examples. Moreover, it can be also measured by B method defined in JIS-K-7126 (equal pressure method) or by using an oxygen permeability measuring apparatus from MOCON Company in accordance with the measuring method shown in ASTM D3985-81.

The fluorine-containing copolymer of the present invention has a good oxygen shielding performance and a high solubility in an organic solvent and is also excellent in forming processability. Moreover, since the molecular weight of the fluorine-containing copolymer is sufficiently high, a membrane having a high practical usefulness can be obtained.

Furthermore, in the fluorine-containing copolymer of the present invention and a membrane thereof, the moisture shielding ability can be also maintained. A moisture permeability coefficient as an index of the moisture shielding ability is preferably from 0 to 20 (g·mm)/(m²·day), particularly preferably 0 to 10 (g·mm)/(m²·day). It is meant that the smaller the value of the coefficient is, the more excellent the moisture shielding ability is.

The moisture shielding ability can be measured by the principle described in Examples. Moreover, it can be also measured by the infrared sensor method defined in JIS-K-7129 (B method) or by using a moisture permeability measuring apparatus from MOCON Company in accordance with ASTM F 1249-90.

The membrane thickness of the membrane composed of the fluorine-containing copolymer of the present invention is preferably from 30 to 2000 μm in the case where the membrane is used as a self-standing membrane and is preferably from 0.05 to 500 μm in the case where the membrane is used as a coating membrane.

The membrane thickness can be changed to any membrane thickness according to intended purpose and required performance. The obtained membrane can be usefully used in the above use applications.

### EXAMPLES

The following will describe the present invention in detail but the present invention is not limited thereto.

In Examples, the molecular weight determined by GPC (using tetrahydrofuran as a solvent for the mobile phase) is a value converted in terms of polystyrenes. Mn represents number-average molecular weight and Mw represents weight-average molecular weight. The glass transition temperature is a value measured by differential scanning calorimetry (DSC). The fluorine content is a value measured using a fully automatic system (AQF-IC (Auto Quick Furnace-Ion Chromatography, AQF: manufactured by DIA Instruments Co. Ltd., IC: manufactured by Dionex Corporation)) wherein a combustion gas of hydrocarbon-based organic substances is trapped in an absorbing liquid and is subsequently transferred to an ion chromatograph (hereinafter referred to as AQF-IC method). The ratio of each monomer unit in the copolymer is a value determined by calculation from the fluorine content determined by the AQF-IC method.

### Example 1

### Production Example of CTFE/N-Vinylcaprolactam Polymer

In a nitrogen globe box kept at 15° C., potassium carbonate (0.043 g) was charged into a stainless steel reactor (inner volume of 16 mL) fitted with paddle wings made of PEEK. Then, the inside of the vessel was purged with nitrogen. Thereafter, a mixed solvent of a hydrochlorofluorocarbon-based solvent (trade name: AK225 manufactured by Asahi Glass Co., Ltd., hereinafter referred to as AK225) and ethanol (AK225/ethanol=78/22 by mass, 2.755 g) and N-vinylcaprolactam (1.258 g) were charged thereto by means of a syringe fitted with a needle.

Then, the inside of the reactor was pressurized with nitrogen to 0.448 MPa (gauge pressure, the same shall apply hereinafter). Thereafter, liquefied CTFE (3.051 g) kept at 15° C. was introduced thereto with pressure and the reactor was heated to 55° C. At the time when the pressure in the reactor was stabilized to 1.48 MPa, t-butyl peroxypivalate (0.00973 g) diluted to 50% with AK225 was introduced thereto with pressure. The reaction temperature was kept at 55° C. to initiate polymerization.

After 20 hours, when the pressure in the reactor was decreased to 0.89 MPa, the vessel was cooled. The monomer in the reactor was purged and the resulting copolymer dispersion was added dropwise into hexane to effect re-precipitation. Furthermore, the resulting precipitate was subjected to vacuum drying at 90° C. for 18 hours to obtain a white copolymer A (2.23 g). As a result of the measurement of the fluorine content by the AQF-IC method, the copolymer A had a fluorine content of 16.1% by mole. Moreover, the copolymer A had a ratio of polymerization unit based on CTFE/polymerization unit based on N-vinylcaprolactam of 47/53 (ratio by mole). Mw of the copolymer A was 65,900, Mw/Mn was 2.11, and the glass transition temperature was 155.4° C.

### Example 2-1

### Production Example of CTFE/CH₂═CHCH₂OCH₂CH═CH₂ Polymer

A white copolymer B (1.87 g) was obtained by carrying out polymerization/purification/drying in the same manner as in Example 1 except that liquefied CTFE (3.528 g) and CH₂═CHCH₂OCH₂CH═CH₂ (0.99 g) as monomers, AK225 (2.82 g) as a solvent, and t-butyl peroxypivalate (0.02810 g) diluted to 50% with AK225 as an initiator were used and potassium carbonate was not used. As a result of the measurement of the fluorine content by the AQF-IC method, the copolymer B had a fluorine content of 25.3% by mole. Moreover, the copolymer B had a ratio of polymerization unit based on CTFE/polymerization unit based on CH₂═CHCH₂OCH₂CH═CH₂ of 56/44 (ratio by mole). Mw of the copolymer B was 20,000, Mw/Mn was 3.12, and the glass transition temperature was 53° C.

### Example 2-2

### Production Example of CTFE/CH₂═CHCH₂OCH₂CH═CH₂ Polymer

A white copolymer B′ (1.60 g) was obtained by carrying out polymerization/purification/drying in the same manner as in Example 2-1 except that 1,1,1,2,2,3,3,4,4,5,5,6,6-tridecafluorohexane was used instead of AK225 as a solvent. As a result of the measurement of the fluorine content by the AQF-IC method, the copolymer B′ had a fluorine content of about 25.3% by mole. Moreover, the copolymer B′ had a ratio of polymerization unit based on CTFE/polymerization unit based on CH₂═CHCH₂OCH₂CH═CH₂ of about 56/44 (ratio by mole). Mw of the copolymer B′ was 12,700 and Mw/Mn was 2.16.

### Example 3-1

### Production Example of CTFE/4-methyl-1-pentene polymer

A white copolymer C (1.29 g) was obtained by carrying out polymerization/purification/drying in the same manner as in Example 1 except that liquefied CTFE (3.485 g) and 4-methyl-1-pentene (0.839 g) as monomers, AK225 (2.7 g) as a solvent, and t-butyl peroxypivalate (0.02776 g) diluted to 50% with AK225 as an initiator were used and potassium carbonate was not used. As a result of the measurement of the fluorine content by the AQF-IC method, the copolymer C had a fluorine content of 25.7% by mole. Moreover, the copolymer C had a ratio of polymerization unit based on CTFE/polymerization unit based on 4-methyl-1-pentene of 61/39 (ratio by mole). When the molecular weight of the copolymer C was measured by GPC (THF solvent), the weight-average molecular weight (Mw) was 11,500 and Mw/Mn was 1.43. The glass transition temperature measured by differential scanning calorimetry (DSC) was 35° C.

### Example 3-2

### Production Example of CTFE/4-methyl-1-pentene polymer

A white copolymer C′ (0.95 g) was obtained by carrying out polymerization/purification/drying in the same manner as in Example 1 except that liquefied CTFE (4.286 g) and 4-methyl-1-pentene (0.344 g) as monomers, AK225 (2.84 g) as a solvent, and t-butyl peroxypivalate (0.1388 g) diluted to 50% with AK225 as an initiator were used and potassium carbonate was not used. The fluorine content of the copolymer C′ fallen within the range of 15 to 77% by mole. Moreover, the ratio of polymerization unit based on CTFE/polymerization unit based on 4-methyl-1-pentene fell within the range of 3 to 99/97 to 1 (ratio by mole). Mw of the copolymer C′ was 15,500 and Mw/Mn was 1.43.

### Example 4

### Production Example of CTFE/N,N-dimethylacrylamide polymer

A white copolymer D (2.99 g) was obtained by carrying out polymerization/purification/drying in the same manner as in Example 1 except that liquefied CTFE (3.645 g) and N,N-dimethylacrylamide (1.034 g) as monomers, AK225 (2.93 g) as a solvent, and t-butyl peroxypivalate (0.01452 g) diluted to 50% with AK225 as an initiator were used and potassium carbonate was not used. As a result of the measurement of the fluorine content by the AQF-IC method, the copolymer D had a fluorine content of about 15% by mole. Moreover, the copolymer D had a ratio of polymerization unit based on CTFE/polymerization unit based on N,N-dimethylacrylamide of about 36/64 (ratio by mole). Mw of the copolymer D was 119,500, Mw/Mn was 1.41, and the glass transition temperature measured by differential scanning calorimetry (DSC) was 116.5° C.

### Example 5

### Production Example of CTFE/methyl 2-fluoroacrylate polymer

A white copolymer E (2.99 g) was obtained by carrying out polymerization/purification/drying in the same manner as in Example 1 except that liquefied CTFE (3.645 g) and methyl 2-fluoroacrylate (0.99 g) as monomers, AK225 (2.9 g) as a solvent, and t-butyl peroxypivalate (0.01452 g) diluted to 50% with AK225 as an initiator were used and potassium carbonate was not used. As a result of the measurement of the fluorine content by the AQF-IC method, the copolymer E had a fluorine content of 17.8% by mole. Moreover, the copolymer E had a ratio of polymerization unit based on CTFE/polymerization unit based on methyl 2-fluoroacrylate of 3/97 (ratio by mole). The copolymer did not dissolve in tetrahydrofuran but dissolved in dichloromethane. Mw of the copolymer E fell within the range of 1,000 to 1,000,000. The glass transition temperature was 133° C.

### Example 6

### Production Example of Polymer Film (Spin Coating Method)

Each of the copolymers was dissolved in tetrahydrofuran at 10% concentration and the resulting solution was filtrated through a 1 μm filter. Subsequently, the filtrate was added dropwise into hexane to re-precipitate the copolymer. The precipitate was dried under vacuum at 60° C. for 15 hours (in the case where the copolymer has a low solubility in THF, it was washed with THF). Then, the copolymer dried in a clean room was again dissolved in 2,6-dimethyl-4-heptanone at 20% concentration and the resulting solution was filtrated through a 0.2 μm filter. One mL of the filtrate was added dropwise onto a polycarbonate film having a diameter of 10 cm and a thickness of 125 μm to carry out spin coating. As a spin coater, WS-400A-6NPP manufactured by Laurell Company was used. Moreover, the spin coating was carried out under conditions of rotation at 500 rpm for 10 seconds, followed by a rapid acceleration to 1000 rpm for 20 seconds. After the spin coating was completed, the coated polycarbonate substrate was dried on a hot plate set at 145° C. for 5 minutes and was cut into disks having a diameter of 3.2 cm to be used as samples for oxygen and moisture permeability measurements, by means of a punching cutter.

### Example 7

### Production Example of Polymer Film (Melt Press Method)

In the case where a film having an increased thickness is desired for the purpose of increasing the accuracy of oxygen and moisture permeability measurements or in the case where the solvent solubility of the resulting polymer is low, a melt press method was adopted. As a press machine, a press machine manufactured by Fontijne Company comprising three press plates fitted with heating and cold water-cooling capability and a vacuum chamber was used. The portion sandwiched between two press plates can be simultaneously loaded with 9 samples, each sandwiched portion could have independent temperature control, and a maximum of 18 samples could be pressed at one time at two press portions. The melting point of the copolymer at the melt press was determined by a preliminary test using the copolymer (about 0.07 g) after purification by re-precipitation. As a result, in the case where the melting point of the copolymer was 150° C. or higher, a release film such as a polyimide film was placed at an opening (7.7 cm in diameter) of a spacer having a thickness of 100 μm placed on a PTFE-coated aluminum sheet and, after about 0.3 g of the copolymer was loaded on the release film, a release base material (polyimide film or PTFE coated aluminum plate) was overlaid thereon. Subsequently, the copolymer was pressed at the melting temperature (155° C. to 320° C.) of the copolymer for 25 minutes at a force of 125 kN to obtain a self-standing membrane. Then, for use of the resulting self-standing membrane as a sample for oxygen and moisture permeability measurements, the membrane was sandwiched between two sheets of a polycarbonate film (thickness of 125 μm) and was cut into disks having a diameter of 3.2 cm by means of a punching cutter. On the other hand, in the case where the melting point of the copolymer was 150° C. or lower, a polycarbonate film (thickness of 125 μm) was placed at an opening (7.7 cm in diameter) of a spacer having a thickness of 100 μm, about 0.3 g of the copolymer was loaded on the film, and a release base material (polyimide or PTFE coated aluminum plate) was overlaid thereon. Subsequently, the copolymer was pressed at the melting temperature (100° C. to 150° C.) of the copolymer for 25 minutes at a force of 125 kN to obtain a film wherein the copolymer was laminated on the polycarbonate film. Then, for use of the resulting laminated film membrane as a sample for oxygen and moisture permeability measurements, the membrane was cut into disks having a diameter of 3.2 cm by means of a punching cutter.

### Example 8

### Evaluation of Membrane (Oxygen Permeability Measurement)

The oxygen permeability for different polymer films were measured by means of an apparatus fitted with chambers capable of simultaneous parallel measurement of 12 samples manufactured by Symyx Technologys Inc. Each chamber was divided into two compartments by the film at the center of the chamber. An oxygen sensor (GE Panametrics O₂X1 IS) was installed in one compartment (volume: 9.3 cm³) and a mixed gas of oxygen/nitrogen (50/50%) at 35% RH at 40° C. was constantly flowing through another compartment with a slightly positive pressure (6.895×10⁻³ kPa to 13.79×10⁻³ kPa) during the measurement. The film area being in contact with oxygen was about 4.6 cm². Each oxygen sensor was calibrated using a standard gas (nitrogen gas containing 500 ppm oxygen). The signal of each oxygen sensor was converted to oxygen concentration using the calibration coefficient. Furthermore, for the preparation of the measurement, in order to completely remove the oxygen in the chamber, two compartments were purged with nitrogen for 3 hours before the measurement. Although it depends on the oxygen permeability, the measurement time for most of the oxygen permeability measurements was 24 hours. The measured oxygen permeability coefficients were converted to values per unit volume and unit area by the volume of the sensor compartment and the film area being in contact with the oxygen.

### Example 9

### Evaluation of Membrane (Moisture Permeability Measurement)

The moisture permeability for different polymer films was measured in the same manner as the oxygen permeability measurement in Example 8. An apparatus for measuring moisture permeability comprised chambers capable of simultaneous parallel measurement of 12 samples. Each chamber was divided into two compartments by the film at the center of the chamber. A moisture sensor (Kahn Instruments, EasiDew, 1 to 1000 ppm) was installed in one compartment (volume: 9.3 cm³) and a nitrogen gas at 35% RH at 40° C. was constantly flowing through another compartment with a slightly positive pressure (6.895×10⁻³ kPa to 13.79×10⁻³ kPa) during the measurement. Moreover, for the preparation of the measurement, in order to completely remove the moisture in the chamber, two compartments were purged with nitrogen for 3 hours before the measurement. Although it depends on the moisture permeability, the measurement time for most of the moisture permeability measurements was 24 hours. The measured dew points were converted into moisture concentration and moisture permeability coefficients were calculated based on the volume of the sensor compartment, the film area, and the slope of the moisture permeability curve when the measurement time was plotted on the X-axis. The calculation of the slope was performed with selecting only the region where the moisture permeability curve was linearly changed.

### [Evaluation Results]

Using the polymers produced in Examples 1 to 5, films were formed. The formation of the films for evaluation was attempted by the melt press method and the spin coating method. In the case where the solubility of the polymer to a solvent was good, films were obtained by both methods. However, in the case where the solubility of the polymer to a solvent was low, a film was obtained by the melt press method. The evaluation results in the specification relates to the films obtained by the melt press method. The oxygen permeability (unit: (cm³·mm)/(m²·day·atm)) and moisture permeability (unit: (g·mm)/(m²·day) were evaluated on the resulting films by the aforementioned methods. The results are shown in Table 1. The symbol “-” in Table 1 shows that the permeability is not measured.

TABLE 1

| | | Weight-average | Molecular | Oxygen | Moisture |
|---|---|---|---|---|---|
| Production | | molecular | weight | permeability | permeability |
| Example of | | weight | distribution | (cm³ · mm)/ | (cm³ · mm)/ |
| polymer | Copolymer | (Mw) | (Mw/Mn) | (m² · day · atm) | (m² · day · atm) |
| 1 | A | 65,900 | 2.11 | 0.60 | 4.70 |
| 2-1 | B | 20,000 | 3.12 | — | — |
| 2-2 | B′ | 12,700 | 2.16 | 1.85 | 7.42 |
| 3-1 | C | 11,500 | 1.43 | — | — |
| 3-2 | C′ | 15,500 | 1.43 | 7.50 | 0.39 |
| 4 | D | 119,500 | 1.41 | 8.10 | 9.54 |
| 5 | E | impossible | impossible | 3.00 | 9.50 |
| | | to measure | to measure | | |
| PCTFE | — | impossible | impossible | 0.61 | 0.16 |
| (Reference | | to measure | to measure | | |
| Example) | | | | | |

### Example 10

Using a T-die extruder of 65 mmφ, the copolymer A described in Example 1 is formed into a film roll of 100 μm at 230° C. (chill roll temperature=30° C.). Using it as a whole cloth, a test for packaging a snack (potato chips) immediately after production is performed. An APEX packaging machine manufactured by Ishida Co., Ltd. is used as a packaging machine and N₂ replacement is also performed. The APEX packaging machine is disclosed in U.S. Pat. No. 5,347,795.

The obtained package is placed in a constant-temperature chamber to perform a “storage test at 40° C. for 1 month” and then is subjected to a sensory test by 10 panelists. Evaluation is as follows: the score immediately after production is 5.0, the score of 3.0 is regarded as a limit of relish, and the score of 3.0 or more is regarded to be commercially valuable. “Flavor at opening” means evaluation of flavor at the time when the package is opened and “taste/flavor” means evaluation of taste and flavor when the potato chips are eaten. Both of “flavor at opening” and “taste/flavor” are evaluated as 4.5 or more and thus are excellent.

While the invention has been described in detail and with reference to specific embodiments thereof, it will be apparent to one skill in the art that various changes and modification can be made therein without departing from the sprit and scope thereof.

This application is based on Japanese patent application No. 2009-178797 filed on Jul. 31, 2009, the entire contents of which are incorporated hereto by reference.

### INDUSTRIAL APPLICABILITY

According to the present invention, there is provided a copolymer of CTFE and a specific monomer copolymerizable with CTFE, which exhibits oxygen shielding performance, solubility in an organic solvent, and formability and maintains moisture permeability. According to the present invention, a copolymer excellent in practical usefulness as compared with PCTFE and a membrane obtained from the copolymer can be provided.

The membrane is useful as a film such as a food packaging film, an electronic part packaging film, a medicament packaging film, a barrier film for organic EL, or a gas barrier film for LCD, an LED encapsulating film, a coating agent for forming a weather resistant layer of a solar battery module, a coating agent for imparting moisture shielding performance and oxygen shielding performance to a surface sheet or a back sheet of a solar battery, or the like.

1: A fluorine-comprising copolymer, comprising:
monomer units (A) of chlorotrifluoroethylene; and
monomer units (B) obtained by polymerizing any one monomer selected from the group consisting of:
(b1) a monomer of formula CH₂═CHCOON(R⁰)₂, wherein each R⁰ is independently a hydrogen atom or an alkyl group;
(b2) N-vinylcaprolactam;
(b3) a monomer of formula CH₂═CR¹CH₂OCH₂CR²═CH₂, wherein R¹ and R² are each independently a hydrogen atom, a fluorine atom, or a methyl group;
(b4) a monomer of formula CH₂═CHCH₂CH(CH₃)—R³, wherein R³ is a linear alkyl group comprising 1 to 7 carbon atoms; and
(b5) a monomer of methyl 2-fluoroacrylate,
wherein:
a ratio of a number of moles of the monomer unit (A) to a total number of moles of the monomer unit (A) and the monomer unit (B), (A)/(A+B), is from 3 to 99% by mole;
a molecular weight of the fluorine-comprising copolymer is of from 1,000 to 1,000,000; and
a ratio of a total number of moles of fluorine atoms to a total number of moles of halogen atoms and hydrogen atoms bonded to carbon atoms of the fluorine-comprising copolymer is of from 15 to 75% by mole.

2: The fluorine-containing fluorine-comprising copolymer of claim 1, wherein the monomer unit (B) is obtained by polymerizing (b1) a monomer of formula CH₂═CHCOON(R⁰)₂, and
wherein the ratio, (A)/(A+B), is from 16 to 99% by mole and a ratio of the number of moles of the monomer unit (B) to the total number of moles, (B)/(A+B), is from 84 to 1% by mole.

3: The fluorine-comprising copolymer of claim 1, wherein the monomer unit (B) is obtained by polymerizing (b1) N,N-dimethylacrylamide, and
wherein the ratio, (A)/(A+B), is from 36 to 60% by mole and a ratio of the number of moles of the monomer unit (B) to the total number of moles, (B)/(A+B), is from 64 to 40% by mole.

4: The fluorine-comprising copolymer of claim 1, wherein the monomer unit (B) is obtained by polymerizing (b2) N-vinylcaprolactam, and
wherein the ratio, (A)/(A+B), is from 45 to 99% by mole and a ratio of the number of moles of the monomer unit (B) to the total number of moles, (B)/(A+B), is from 55 to 1% by mole.

5: The fluorine-comprising copolymer of claim 1, wherein the monomer unit (B) is obtained by polymerizing (b3) a monomer of formula CH₂═CR¹CH₂OCH₂CR²═CH₂, and
wherein the ratio, (A)/(A+B), is from 10 to 99% by mole and a ratio of the number of moles of the monomer unit (B) to the total number of moles, (B)/(A+B), is from 90 to 1% by mole.

6: The fluorine-comprising copolymer of claim 1, wherein the monomer unit (B) is obtained by polymerizing (b4) a monomer of formula CH₂═CHCH₂CH(CH₃)—R³, and
wherein the ratio, (A)/(A+B), is from 43 to 99% by mole and a ratio of the number of moles of the monomer unit (B) to the total number of moles, (B)/(A+B), is from 57 to 1% by mole.

7: fluorine-comprising copolymer of claim 1, wherein the monomer unit (B) is obtained by polymerizing (b4) a monomer of formula CH₂═CHCH₂CH(CH₃)₂, and
wherein the ratio, (A)/(A+B), is from 43 to 70% by mole and a ratio of the number of moles of the monomer unit (B) to the total number of moles, (B)/(A+B), is from 57 to 30% by mole.

8: The fluorine-comprising copolymer of claim 1, wherein the monomer unit (B) is obtained by polymerizing (b5) a monomer of methyl 2-fluoroacrylate, and
wherein the ratio, (A)/(A+B), is from 3 to 20% by mole and a ratio of the number of moles of the monomer unit (B) to the total number of moles, (B)/(A+B), is from 97 to 80% by mole.

9: The fluorine-comprising copolymer of claim 1, having an oxygen permeability coefficient of from 0 to 20 (cm³·mm)/(m²·day·atm) at 40° C.

10: A membrane, comprising fluorine-comprising copolymer comprising:
monomer units (A) of chlorotrifluoroethylene; and
monomer units (B) obtained by polymerizing any one monomer selected from the group consisting of:
(b1) a monomer of formula CH₂═CHCOON(R⁰)₂, wherein each R⁰ is independently a hydrogen atom or an alkyl group;
(b2) N-vinylcaprolactam;
(b3) a monomer of formula CH₂═CR¹CH₂OCH₂CR²═CH₂, wherein R¹ and R² are each independently a hydrogen atom, a fluorine atom, or a methyl group;
(b4) a monomer of formula CH₂═CHCH₂CH(CH₃)—R³, wherein R³ is a linear alkyl group comprising 1 to 7 carbon atoms; and
(b5) a monomer of methyl 2-fluoroacrylate,
wherein:
a ratio of a number of moles of the monomer unit (A) to a total number of moles of the monomer unit (A) and the monomer unit (B) is of from 3 to 99% by mole;
a molecular weight of the fluorine-comprising copolymer is of from 1,000 to 1,000,000;
an oxygen permeability coefficient of the fluorine-comprising copolymer is of from 0 to 20 (cm³·mm)/(m²·day·atm) at 40° C.; and
a ratio of a total number of moles of fluorine atoms to a total number of moles of halogen atoms and hydrogen atoms bonded to carbon atoms of the fluorine-containing copolymer is of from 15 to 75% by mole.

11: The membrane of claim 10, having a thickness of from 0.05 to 2,000 μm.

12: The membrane of claim 10, which is a film or a coating membrane.

13: A process for producing a coating membrane, the process comprising:
contacting an organic solvent solution comprising the fluorine-comprising copolymer of claim 1 and an organic solvent with a surface of a substrate; and subsequently,
drying the solution, to form a membrane of the fluorine-comprising copolymer on the substrate.

14: The fluorine-comprising copolymer of claim 4, wherein the ratio, (A)/(A+B), is from 45 to 90% by mole and the ratio, (B)/(A+B), is from 55 to 10% by mole.

15: The fluorine-comprising copolymer of claim 4, wherein the ratio, (A)/(A+B), is from 45 to 85% by mole and the ratio, (B)/(A+B), is from 55 to 15% by mole.

16: The fluorine-comprising copolymer of claim 5, wherein the ratio, (A)/(A+B), is from 39 to 85% by mole and the ratio, (B)/(A+B), is from 61 to 15% by mole.

17: The fluorine-comprising copolymer of claim 1, wherein the ratio of a total number of moles of fluorine atoms to a total number of moles of halogen atoms and hydrogen atoms bonded to carbon atoms of the fluorine-comprising copolymer is of from 15 to 70% by mole.

18: The fluorine-comprising copolymer of claim 1, having an oxygen permeability coefficient of from 0 to 10 cm³·mm/(m²·day·atm) at 40° C.

19: The membrane of claim 10, having an oxygen permeability coefficient of from 0 to 10 cm³·mm/(m²·day·atm) at 40° C.

20: The membrane of claim 10, having a thickness of from 0.05 to 500 μm.
